(19) United States
(12) Patent Application Publication
(10) Pub. No.: US 2009/0008377 A1
(43) Pub. Date: Jan. 8, 2009

(54) Occupant sensing heat mat

(75) Inventors: John F. Nathan, Highland, MI (US); Karl Kennedy, Fraser, MI (US); H. Winston Maue, Farmington Hills, MI (US); Santosh Karumathil, Thane (IN)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/825,210

(22) Filed: Jul. 5, 2007

(51) Int. Cl. H05B 1/00

(52) U.S. Cl. 219/217; 340/667

(57) ABSTRACT

A seat heating and occupant sensing assembly including a mat having a plurality of heat sources disposed therein. A power supply supplies power to the heat sources. The assembly further includes a controller in communication with a signal generator. The signal generator provides electric signals to the heat sources to form an electric field. The controller monitors one of the signals and electric field for recognizable characteristics for determining the presence of an occupant on the seat.

### BACKGROUND OF THE INVENTION

This invention relates in general to heat pads and more particularly to heat pads for use in seats.

Seats, such as those used in vehicles, have been provided with heat pads adapted to heat the surface of the seat for the comfort of the seat occupant. The seat heat pads are commonly integrated into seat backs and seat cushions. It has also been known to further provide separate sensor elements configured to sense the presence of a seat occupant for initiating and controlling various systems, such as for example air bags and other various occupant restrain systems. The heating pads and the occupant detection sensors are separate systems installed in the seat, such as disclosed in U.S. Pat. No. 6,812,431.

While separate heat pads and sensor elements have been effective in vehicle seats, it would be advantageous to provide an improved heat pad and sensor system.

### SUMMARY OF THE INVENTION

This invention relates to vehicle seats having seat heating and occupant sensing, and in particular to a mat incorporating both of these features. The mat has a plurality of heat sources disposed therein. A power supply supplies power to the heat sources. The assembly further includes a controller in communication with a signal generator. The signal generator provides electric signals to the heat sources to form an electric field. The controller monitors one of the signals and electric field for recognizable characteristics for determining the presence of an occupant on the seat.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a seat having an occupant sensing heat mat in accordance with this invention.

FIG. 2 is a front cross-sectional view of a portion of the seat and the occupant sensing heat mat of FIG. 1.

FIG. 3 is a perspective view of the occupant sensing heat mat of FIG. 1 illustrating a plurality of heating grids.

### DETAILED DESCRIPTION OF THE PREFERRED EMBODIMENT

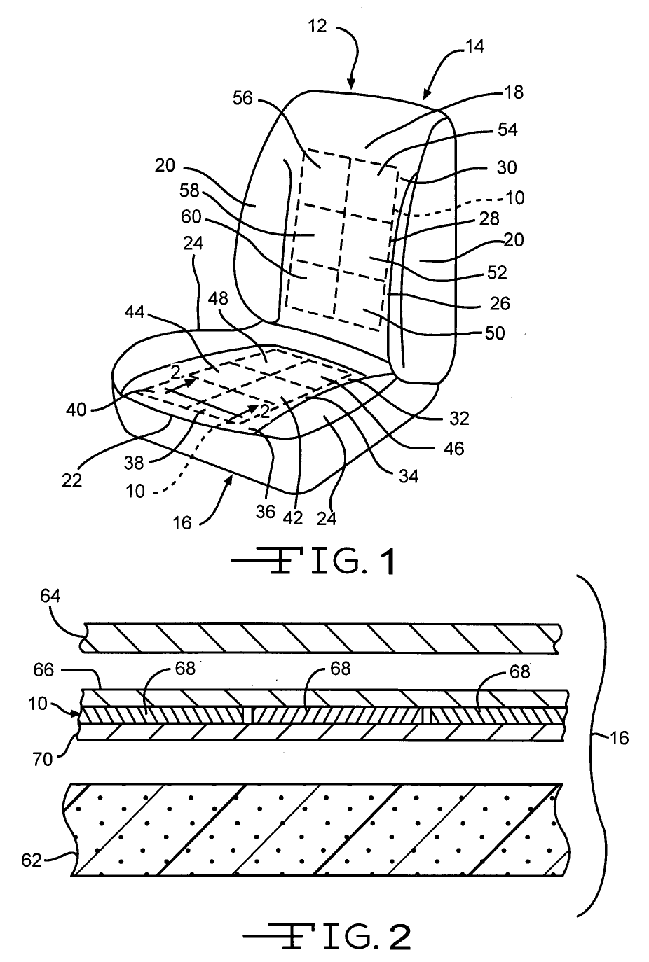

Referring now to the drawings, there is illustrated in FIG. 1 a seat, indicated generally at 12, having a plurality of occupant sensing heat mats 10 in accordance with this invention. As will be explained in detail below, the plurality of occupant sensing heat mats 10 are adapted to provide heat to the seat 12 and additionally preferably include an occupant sensor assembly for detecting the presence of an occupant on the seat 12 integrally contained within a common housing or mat instead on the conventionally known manner of providing separate structures.

As further shown in FIG. 1, the vehicle seat 12 includes a seat back 14 and a seat cushion 16. The seat back 14 includes a back support 18 and a plurality of back bolsters 20. The seat cushion 16 includes a seat support 22 and a plurality of seat bolsters 24. The back support 18 includes a low back area 26, mid back area 28 and upper back area 30. Similarly, the seat support 22 includes rear seat area 32, mid seat area 34 and front seat area 36.

In the embodiment shown in FIG. 1, an occupant sensing heat mat 10 is disposed in the back support 18 and in the seat support 22. Alternatively, an occupant sensing heat mat 10 can be disposed only in the back support 18 or only in the seat support 22.

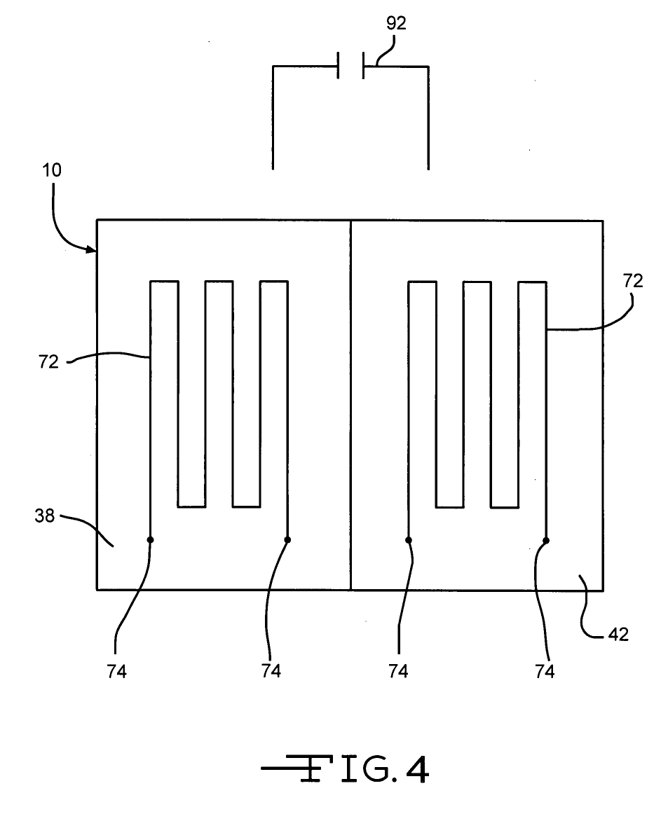

As further shown in FIG. 1, the occupant sensing heat mat 10 disposed in the seat support 22 includes a plurality of zones 38, 40, 42, 44, 46 and 48. A zone is defined as a section of the occupant sensing heat mat 10 having a heating element which can be independently controlled from other heating elements in other sections. Thus, in the embodiment shown in FIG. 3, the occupant sensing heat mat 10 is shown with six zones, each zone potentially having one heating element therein.

While the occupant sensing heat mat 10 illustrated in FIG. 1 has six zones, it should be understood that the occupant sensing heat mat 10 can contain any number of zones including just a single zone. In the illustrated embodiment, the zones 38 and 40 generally correspond to the front seat area 34, zones 42 and 44 generally correspond to the mid seat area 34 and zones 48 and 46 generally correspond to the rear seat area 32.

As further shown in FIG. 1, the occupant sensing heat mat 10 disposed in the back support 18 includes a plurality of zones 50, 52, 54, 56, 58 and 60. While the occupant sensing heat mat 10 positioned within the back support 18 has six zones, it should be understood that the occupant sensing heat mat 10 preferably has a minimum of two zones but may have any number of zones. In the illustrated embodiment, the zones 50 and 60 generally correspond to the lower back 26, zones 52 and 58 generally correspond to the mid back area 28 and zones 54 and 56 generally correspond to the upper back area 30.

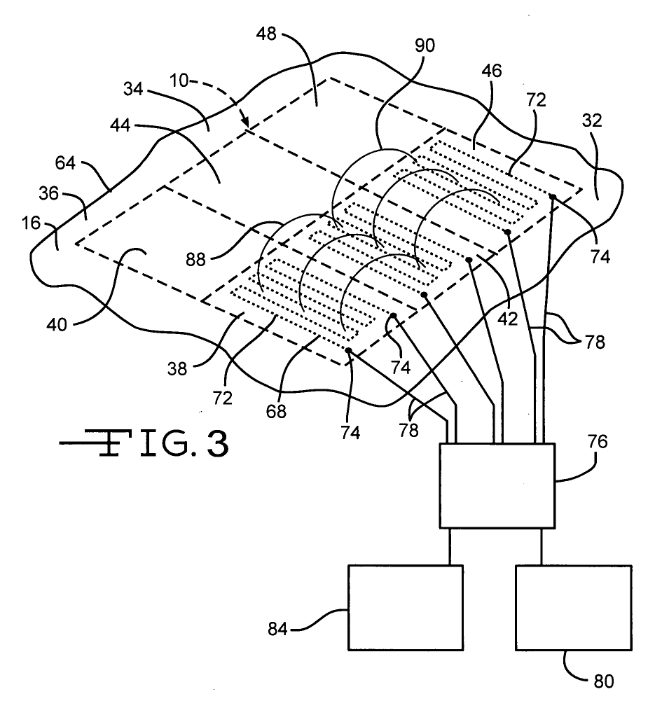

As shown in FIG. 2, the seat cushion 16 includes a base material 62 covered by a seat trim covering 64. The base material 62 is adapted to provide padding to the seat cushion 16. In one embodiment, the base material 62 is a synthetic foam material. In another embodiment, the base material 62 can be another material sufficient to provide padding to the seat cushion 16. As shown in FIG. 2, the seat trim covering 64 is adapted to provide a protective and aesthetically pleasing cover to the seat cushion 16. In one embodiment, the seat trim covering 64 is a fabric based material. In another embodiment, the seat trim covering 64 can be another material, such as for example leather, sufficient to provide a protective and aesthetically pleasing cover to the seat cushion 16.

As further shown in FIG. 2, the seat cushion 16 also includes an occupant sensing heat mat 10. The occupant sensing heat mat 10 includes an upper layer 66, a plurality of elements, hereinafter referred to as heat sources 68, and a lower layer 70. The upper layer 66 and lower layer 70 are adapted to protect the plurality of heat source 68 from incidental damage and electrically isolate the heat sources 68 from other portions of the seat cushion 16. In the illustrated embodiment, the upper layer 66 and the lower layer 70 are made of a felt material. Alternatively, the upper layer 66 and the lower layer 70 can be another material, such as for example a fabric based material, sufficient to protect the plurality of heat source 68 from incidental damage and electrically isolate the heat sources 68 from other portions of the seat cushion 16. While FIG. 2 illustrates a space between the upper layer 66, the plurality of heat sources 68 and the lower layer 70, it should be understood that the upper layer 66 may be in contact with the plurality of heat sources 68, and the plurality of heat sources 68 may be in contact with the lower layer 70. While the illustrated embodiment shows an upper layer 66, a plurality of heat sources 68 and a lower layer 70, it should be understood that additional layers, such as for example a thermally reflective layer, can be used.

Referring now to FIG. 3, a seat cushion 16 is shown including the seat trim covering 64 and the occupant sensing heat mat 10. As previously described, the seat cushion 16 includes rear seat area 32, mid seat area 34 and front seat area 36. The rear seat area 32 includes zones 48 and 46 of the occupant sensing heat mat 10, the mid seat area 34 includes zones 42 and 44 of the occupant sensing heat mat 10, and the front seat area 36 includes zones 38 and 40 of the occupant sensing heat mat 10.

As shown in FIG. 3, zones 38, 42 and 46 each include a heat source 68. The plurality of heat sources 68 are adapted to provide heat to the seat cushion 16. Although for clarity purposes, a heat source 68 is not shown in zones 40, 44 and 48, it should be understood that a heat source 68 is also included in zones 40, 44 and 48.

As illustrated in FIG. 3, one embodiment of the heat source 68 includes a resistive electric grid 72 and a plurality of grid terminals 74. The resistive electric grid 72 is adapted to receive electric power through the grid terminals 74 and provide heat as the electric power flows through the grid 72. The resistive electric grids 72 are rated for a heating density according to the desired heating effect. In one embodiment, the resistive electric grids 72 are rated for a heating density in a range from about 200 watts/m² to about 1200 watts/m² where heat density is defined as the amount of heat dissipated with a given physical area. In another embodiment, the resistive electric grids 72 can be rated for a heating density of more than 1200 watts/m² or less than 200 watts/m².

In the illustrated embodiment, the resistive electric grids 72 use D.C. electrical power flowing through the grids 72 to generate heat therein, thereby providing heat directed to the occupant of the seat 12. The direct current is in a range from about 0.5 amps to about 4.0 amps at a voltage in a range from about 6.0 volts to about 13.0 volts. In another embodiment, the resistive electric grids 72 can use another type of electric power, such as for example A. C., sufficient to flow through the grids 72 and generate heat therein.

While the heat sources 68 illustrated in FIG. 3 are resistive electric grids, it should be understood that other heat sources, such as for example thermal electric devices, conductive carbon fibers, or any other mechanism sufficient to provide heat to the seat cushion 16 can be used.

The grid terminals 74 are connected to a controller 76 by a plurality of grid connectors 78. As will be explained in detail later, the controller 76 is adapted to provide a plurality of functions. The controller 76 is in communication with a power supply 80 which is adapted to provide a supply of electrical power to the controller 76. In the illustrated embodiment, the power supply 80 provides D.C. electrical power. In another embodiment, the power supply 80 can provide another type of electrical power, such as for example A.C. power. The controller 76 includes a power supply switch (not shown) adapted to turn the power supply 80 on and off. In the illustrated embodiment, the controller 76 controls the electrical power supplied to the resistive electric grids 72 by turning power supply 80 on and off. In operation, a seat occupant will desire heat within the seat cushion 16 and will initiate a switch (not shown) within the interior of the vehicle. The switch notifies the controller 76, which in turn, controls the power supply 80 to supply electrical power to the resistive electrical grid 72. In another embodiment, the controller 76 can automatically control the power supply 80 to supply electrical power to the resistive electrical grid 72.

As further shown in FIG. 3, a signal generator 84 is in communication with the controller 76. The signal generator 84 is configured to provide a continuous signal to the controller 76 which controls the transmission of the signal through the elements or heat sources 68 for an occupant detection system. In a preferred embodiment, the presence of an occupant is detected by capacitive sensing as discussed below and such as that disclosed in U.S. Pat. No. 6,812,431 which is incorporated by reference herein. In one embodiment, the signal is a sinusoidal A.C. wave form. In another embodiment, the signal can be another type of signal, such as for example a chopped wave form. The controller 76 is adapted to receive the signal and control the transmission of the signal to the elements or heat sources 68. The controller 76 directs the signals over the grid connectors 78 to the heat sources 68. In this embodiment, the signals travel over the grid connectors 78 and flow through the resistive electric grid 72. Accordingly, each resistive electric grid 72 can simultaneously have electric power for heating purposes and a signal, such as for example a sinusoidal wave form, flowing through it.

While for illustrative purposes in FIG. 3 the power supply 80, the signal generator 84 and the controller 76 are shown as separate components and described in functionality as such, but it should be understood that the power supply 80, the signal generator 84 and the controller 76 can be combined in one module or assembly or can be a single unit performing the above described functions.

As further shown in FIG. 3, the signals flowing through each resistive electric grid 72 act to form an antenna for occupant detection. Each antennae has an electric field, 88 and 90, associated therewith when the signal flows through the electric grid 72. It should be understood that the representation of the shape of the electric fields, 88 and 90, is for illustrative purposes only and the shape of the electric fields, 88 and 90, may have another form.

In general, the antenna and the corresponding electric fields, 88 and 90, are used for the detection of a seat occupant. Each electric field, 88 or 90, has recognizable characteristics that can be detected and monitored. Examples of recognizable characteristics of an electric field, 88 and 90, include field phases, field frequencies and field amplitudes.

As further shown schematically in FIG. 4, during operation a capacitance, represented at 92, is formed between adjacent electric fields, 88 and 90. If the capacitance 92 of the electric fields, 88 and 90, is disturbed such as by the presence of an occupant within that filed, the recognizable characteristics of the electric fields, 88 and 90, change and the change can be detected for determining the presence of an occupant. In the illustrated embodiment, the capacitance 92 between the electric grids 72 is inherent to the presence of the electric grids 72. In another embodiment, the capacitance 92 can be a capacitor disposed between the electric grids. In yet another embodiment, the capacitance 92 can be another component, device or assembly, disposed between the electric grids, 88 and 90, having the capability for being disturbed.

The recognizable characteristics of the electric fields 88 are monitored by the controller 76. The controller 76 includes provisions for monitoring the recognizable characteristics of the electric fields, 88 and 90, and determining a change in the recognizable characteristics. If the recognizable characteristics change, such as for example by an occupant in the seat 12, the change is detected by the controller 76 and the controller 76 notifies other control systems (not shown) of the presence of a foreign object, such as a person, as occupying the seat cushion 16. One example of a controller sensing a change occurs when a seat occupant leans to one side of the seat 12. In that situation, the controller 76 senses changes in the recognizable characteristics of the electric fields 88 and can signal other systems, such as for example the side air bag system (not shown), of the condition.

While the previous description of the occupant sensing heat mat 10 is described in conjunction with the seat cushion 16, it should be understood that the description is the same for the occupant sensing heat mat 10 disposed within the seat back 14.

One benefit of the occupant sensing heat mat 10 is that the heat sources 68 function both as a heat source an as an antennae for the occupant sensing function. This combination prevents a shifting of the heat source relative to the sensing function. Eliminating a shift between the heat source and the sensing function eliminates a source of error in the capacitance 92 between adjacent electric fields, 88 and 90.

Another benefit of the occupant sensing heat mat 10 is that the combination of the heat sources 68 function and the occupant sensing function allows for easier and more accurate service of the occupant sensing heat mat 10. In the event the occupant sensing heat mat 10 is required to be replace, the mat 10 can be replaced and the functions of heat and sensing are integrated into the replacement unit. This eliminates the need for recalibrating between separate systems.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A seat heating and occupant sensing assembly comprising:
a mat;
a plurality of heat sources disposed within the mat;
a power supply supplying power to the heat sources;
a controller;
a signal generator in communication with the controller, the signal generator providing electric signals to the heat sources to form an electric field, and wherein the controller monitors one of the signals and electric field for recognizable characteristics for determining the presence of an occupant on the seat.

2. The assembly of claim 1 in which said mat includes zones.

3. The assembly of claim 2 in which said zones each contain a heat source.

4. The assembly of claim 1 in which said heat sources include a resistive electric grid.

5. The assembly of claim 4 in which said resistive electric grids have a heating density in a range of about 200 watts/m² to about 1200 watts/m².

6. The assembly of claim 4 in which said resistive electric grids use D.C. electrical power to provide heat.

7. The assembly of claim 1 in which said signal from said signal generator in a sinusoidal wave form.

8. The assembly of claim 1 in which said recognizable characteristics of said electric fields include field frequencies.

9. The assembly of claim 1 in which said electric fields are disturbed by the presence of a foreign object.

10. The assembly of claim 9 in which said disturbance causes said controller to notify other control systems.
